(19) United States
(12) Patent Application Publication
(10) Pub. No.: US 2026/0359027 A1
(43) Pub. Date: Nov. 12, 2026

(54) Application Program Processing Method and Apparatus, Device, and Storage Medium

(71) Applicant: Tencent Technology (Shenzhen) Company Limited, Shenzhen (CN)

(72) Inventor: Danxiong Lei, Shenzhen (CN)

(21) Appl. No.: 19/671,595

(22) Filed: May 8, 2026

Related U.S. Application Data
(63) Continuation of application No. PCT/CN2025/078947, filed on Feb. 25, 2025.

(30) Foreign Application Priority Data
Mar. 4, 2024 (CN) 2024102421102

(51) Int. Cl. G06F 8/61; G06F 8/41; G06F 9/445

(52) U.S. Cl. CPC G06F 8/61; G06F 8/41; G06F 9/44526

(57) ABSTRACT

An application program processing method and apparatus, a device, and a storage medium relate to the field of computer technologies. The method comprises: obtaining an uncompiled first subprogram and an uncompiled second subprogram; compiling the uncompiled second subprogram according to the uncompiled first subprogram to obtain a compiled second subprogram, the compiled second subprogram including an executable file in a first format supported to be run in a browser; and transmitting the compiled second subprogram to a second device requesting to download the first application program, for the second device to run the first application program according to the compiled second subprogram and the compiled first subprogram.

### RELATED APPLICATIONS

This application claims priority to PCT/CN2025/078947, filed on Feb. 25, 2025, which claims priority to Chinese Patent Application No. 202410242110.2, filed on Mar. 4, 2024 and entitled “APPLICATION PROGRAM PROCESSING METHOD AND APPARATUS, DEVICE, AND STORAGE MEDIUM”, each of which is incorporated herein by reference in its entirety.

### FIELD OF THE TECHNOLOGY

This application relates to the field of computer technologies, and in particular, to an application program processing method and apparatus, a device, and a storage medium.

### BACKGROUND OF THE DISCLOSURE

With the development of computer technologies, more and more application programs are compiled (e.g., developed) using game engines. The game engines provide various tools required for compiling application programs. Therefore, a code package of a final application program developed by a developer not only includes service code configured for implementing a service logic, but also includes engine code configured for implementing an engine logic.

In a related technology, a code package of an application program needs to be compiled to obtain an executable file that can be run by a terminal device. To obtain an executable file that can be run in a browser, when a code package of an application program is compiled, service code and engine code are usually compiled into the same executable file, that is, the executable file not only includes compiled service code, but also includes compiled engine code.

Therefore, even for different application programs based on the same game engine, each time an application program is downloaded, an executable file that needs to be downloaded includes compiled engine code. This leads to a relatively slow download speed of the application program.

### SUMMARY

This application provides an application program processing method and apparatus, a device, and a storage medium, which can increase a download speed of an application program. The technical solutions provided in this application are as follows:

According to an aspect of an example of this application, an application program processing method is provided, the method is executed by a first device, and the method includes: obtaining an uncompiled first subprogram and an uncompiled second subprogram. The first subprogram is configured to implement an engine logic in a first application program, and the second subprogram is configured to implement a service logic in the first application program. The method further includes compiling the uncompiled second subprogram according to the uncompiled first subprogram to obtain a compiled second subprogram, the compiled second subprogram including an executable file in a first format supported to be run in a browser; and transmitting the compiled second subprogram to a second device requesting to download the first application program, for the second device to run the first application program according to the compiled second subprogram and the compiled first subprogram.

According to an aspect of an example of this application, an application program processing method is provided, the method is executed by a second device, and the method includes: obtaining, based on a download request for a first application program, configuration information corresponding to the first application program, the configuration information including attribute information of a first subprogram and attribute information of a second subprogram. The first subprogram is configured to implement an engine logic in the first application program, and the second subprogram is configured to implement a service logic in the first application program. The method further includes obtaining a compiled first subprogram locally based on determining that the compiled first subprogram exists locally according to the attribute information of the first subprogram; and downloading a compiled second subprogram according to the attribute information of the second subprogram, the compiled second subprogram including an executable file in a first format supported to be run in a browser; and running the first application program according to the compiled first subprogram and the compiled second subprogram.

According to an aspect of an example of this application, an application program processing apparatus is provided, and the apparatus includes: a program obtaining module, configured to obtain an uncompiled first subprogram and an uncompiled second subprogram, the first subprogram being configured for implementing an engine logic in a first application program, and the second subprogram being configured for implementing a service logic in the first application program; a program compiling module, configured to compile the uncompiled second subprogram according to the uncompiled first subprogram to obtain a compiled second subprogram, the compiled second subprogram including an executable file in a first format supported to be run in a browser; and a program distribution module, configured to transmit the compiled second subprogram to a second device requesting to download the first application program, for the second device to run the first application program according to the compiled second subprogram and the compiled first subprogram.

According to another aspect of an example of this application, an application program processing apparatus is provided, and the apparatus includes: an information obtaining module, configured to obtain, based on a download request for a first application program, configuration information corresponding to the first application program, the configuration information including attribute information of a first subprogram and attribute information of a second subprogram, the first subprogram being configured for implementing an engine logic in the first application program, and the second subprogram being configured for implementing a service logic in the first application program; a local obtaining module, configured to obtain a compiled first subprogram locally based on determining that the compiled first subprogram exists locally according to the attribute information of the first subprogram; and a program download module, configured to download a compiled second subprogram according to the attribute information of the second subprogram, the compiled second subprogram including an executable file in a first format supported to be run in a browser; and a program running module, configured to run the first application program according to the compiled first subprogram and the compiled second subprogram.

According to an aspect of an example of this application, a computer device is provided, where the computer device includes a processor and a memory, the memory stores a computer program, and the computer program is loaded and executed by the processor to implement the application program processing method on the first device side or the application program processing method on the second device side.

According to an aspect of an example of this application, a non-transitory computer-readable storage medium is provided, wherein the non-transitory computer-readable storage medium stores a computer program, and the computer program is loaded and executed by a processor to implement the application program processing method on the first device side or the application program processing method on the second device side.

According to an aspect of an example of this application, a computer program product is provided, where the computer program product includes a computer program, and the computer program is loaded and executed by a processor to implement the application program processing method on the first device side or the application program processing method on the second device side.

The technical solutions provided in the examples of this application may provide the following beneficial effects: The first device obtains an uncompiled first subprogram configured for implementing an engine logic and an uncompiled second subprogram configured for implementing a service logic, and compiles the uncompiled second subprogram by using the uncompiled first subprogram, to obtain a compiled second subprogram. The compiled second subprogram includes an executable file in a first format. The uncompiled second subprogram is compiled by using the uncompiled first subprogram, to obtain the compiled second subprogram, so that division is implemented during compiling. When the second device requests to download the first application program, if the compiled first subprogram exists locally in the second device, the second device only needs to download the compiled second subprogram. Therefore, this application implements unpackaging of the engine logic and the service logic of the executable file of the first format, and in a case that the first subprogram configured for implementing the engine logic exists locally, the first subprogram does not need to be repeatedly downloaded. Therefore, in this application, reuse of the engine code (e.g., the compiled first subprogram) can be implemented, and a download volume of the application program is reduced, thereby increasing a download speed of the application program.

### BRIEF DESCRIPTION OF THE DRAWINGS

FIG. 1 is a schematic diagram of a computer system according to an example of this application.

FIG. 2 is a schematic diagram of an application program processing method according to an example of this application.

FIG. 3 is a flowchart of an application program processing method according to an example of this application.

FIG. 4 is a flowchart of an application program processing method according to another example of this application.

FIG. 5 is a flowchart of an application program processing method according to another example of this application.

FIG. 6 is a flowchart of an application program processing method according to another example of this application.

FIG. 7 is a block diagram of an application program processing method according to an example of this application.

FIG. 8 is a block diagram of an application program processing method according to another example of this application.

FIG. 9 is a block diagram of an application program processing apparatus according to an example of this application.

FIG. 10 is a block diagram of an application program processing apparatus according to another example of this application.

FIG. 11 is a structural block diagram of a computer device according to an example of this application.

### DETAILED DESCRIPTION

To make objectives, technical solutions, and advantages of this application clearer, the following further describes implementations of this application in detail with reference to the accompanying drawings.

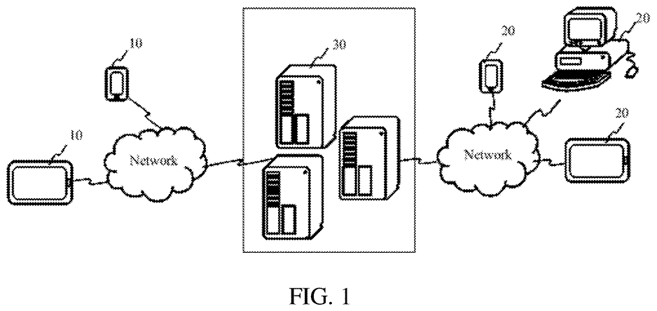

Refer to FIG. 1, which is a schematic diagram of a computer system according to an example of this application. The computer system may include a first terminal device 10, a second terminal device 20, and a server 30.

The first terminal device 10 includes, but is not limited to, an electronic device such as a mobile phone, a tablet computer, a smart voice interaction device, a game console, a wearable device, a multimedia playback device, a personal computer (PC), an in-vehicle terminal, or a smart home appliance. The first terminal device 10 is a terminal device provided with a compiling function. For example, a compiling application program runs on the first terminal device 10, and the compiling application program provides a compiling function. In some examples, the first terminal device 10 is a terminal device that provides a compiling function for a target application program. In some examples, a client of a compiling application program that provides a compiling function may be installed in the first terminal device 10. For example, the target application program may be compiled by using the compiling application program, to obtain a compiled executable file. For example, the compiled executable file can be run on the second terminal device 20. A type of the compiling application program running on the first terminal device 10 is also not limited in this example of this application. For example, the compiling application program is an application program that needs to be downloaded and installed, or may be an application program (such as a mini program) that is ready for use. Certainly, the compiling application program may be an independent application program, or may be implemented as a module having a compiling function. In addition to the module having a compiling function, the client installed on the first terminal device 10 may include another functional module, such as a code writing module.

The second terminal device 20 includes, but is not limited to, an electronic device such as a mobile phone, a tablet computer, a smart voice interaction device, a game console, a wearable device, a multimedia playback device, a PC, an in-vehicle terminal, or a smart home appliance. In some examples, the second terminal device 20 is a terminal device configured to download and run a program. In some examples, the second terminal device 20 may obtain an installation package of the target application program. In some examples, the second terminal device 20 may install a client of the target application program based on the installation package of the target application program. In some examples, the target application program may be developed by the first terminal device 10, and the installation package of the target application program is developed by the first terminal device 10. For example, the target application program may be an application program that needs to be downloaded and installed, or may be an application program (for example, a mini program) that is ready for use. This is not limited in this example of this application. A type of the target application program is not limited in this example of this application. For example, the target application program is an application program obtained based on a game engine. For example, the target application program is any one of a virtual reality (VR) game, an augmented reality (AR) game, a first-person shooting game (FPS), a multiplayer firearm survival game, a third-person shooting game (TPS), a multiplayer online battle arena (MOBA) game, a simulation game (SLG), a social application program, or an interactive entertainment application program. In some examples, if the second terminal device 20 wants to download and install the target application program, the second terminal device 20 may obtain the compiled executable file obtained by the first terminal device 10 by compiling the target application program, to obtain the target application program. In some examples, in a case that the compiled first subprogram is locally stored in the second terminal device 20, the second terminal device 20 only needs to obtain the compiled executable file and does not need to repeatedly download the compiled first subprogram, so that the engine code (that is, the compiled first subprogram) is reused.

In some examples, the server 30 is configured to provide a background service for a client of a compiling application program in the first terminal device 10. In some other examples, the server 30 is configured to provide a background service for the client of the target application program in the second terminal device 20. For example, the server 30 may be an independent physical server, or may be a server cluster or a distributed system formed by a plurality of physical servers, or may be a cloud server that provides a basic cloud computing service such as a cloud service, a cloud database, cloud computing, a cloud function, cloud storage, a network service, cloud communication, a middleware service, a domain name service, a security service, a content delivery network (CDN), big data, and an artificial intelligence platform, but is not limited thereto.

In some examples, the server 30 includes at least one of a first server 31 and a second server 32 (not shown in the figure). For example, the first server 31 is configured to provide a background service for the compiling application program in the first terminal device 10. For example, the second server 32 is configured to provide a background service for the target application program in the second terminal device 20. For example, the first server 31 and the second server 32 may be the same server or different servers.

The first terminal device 10 and the server 30 may communicate with each other by using a network. The second terminal device 20 and the server 30 may alternatively communicate with each other by using a network. The network may be a wired network, or may be a wireless network.

According to the application program processing method provided in this example of this application, each operation may be performed by a computer device. The computer device may be any electronic device that has a data storage and processing capability. For example, the computer device includes a first device and a second device. For example, the first device may be the first terminal device 10 or the server 30 in FIG. 1. For example, the second device may be the second terminal device 20 or the server 30 in FIG. 1.

First, the related background technology is explained and described.

Using an example in which the first application program (the target application program) is a mini game (e.g., a click-to-play application program), a code package of the mini game mainly includes a game engine, a service code, and related resources. The proportion of the game engine part in the code package is very high. This leads to a relatively long download time of the installation package, e.g., a long download time during cold start.

For games currently on the market, leading distribution and version distribution of game engines used in the games are very concentrated, that is, the game engines used in the games are relatively fixed. Based on this, it is considered that a game engine is separated from an installation package, so that many mini games reuse the same engine code as much as possible.

For example, when a player opens a new mini game, only a code package in which engine code is excluded needs to be downloaded. The engine code is reused for optimizing a cold start speed of the mini game. In addition, because the player directly uses local engine code for reuse, network download bandwidth of the server and occupation of storage space of a user are reduced.

In some examples, when the first application program is a standard mini game (a game whose game scale is less than a threshold), JavaScript (JS) is usually configured for describing an execution logic of the first application program, engine code and service code both use JS, and a main user is Cocos (a game engine). An engine whose engine code uses JS is considered as a JS engine below.

For example, for a JS engine, engine code and service code are usually located in different JS files. Therefore, during compiling, it is easy to compile the engine code and the service code into different files, to implement code segmentation.

In some other examples, when the first application program is a resource-intensive mini game (a game whose game scale is greater than or equal to a threshold), Web Assembly (WASM) is usually configured for describing the execution logic of the first application program, engine code and service code are both compiled into WASM, and a main user is Unity. An engine whose engine code uses WASM is considered as a WASM engine below.

For example, for a WASM engine, engine code and service code are compiled and are compiled into the same file. Therefore, it is difficult to split a code package that has been compiled into the same file, so as to implement reuse of the engine. Therefore, based on this case, the service code and the engine code need to be split before compiling.

For example, for a WASM engine, a volume of the engine is relatively large, and if all engine code is directly used as an engine plugin, a download volume of the engine plugin is relatively large. For example, a mini game uses only a small quantity of engine functions in the WASM engine, but still needs to download a relatively large engine plugin. This also causes a relatively large download volume. Therefore, in this application, it is considered to tailor the engine code, that is, delete parts not very important in all engine code, and reserve a part that needs to be used in most games. This part of engine code is used as an engine plugin. In this way, a reuse rate of an engine function in a locally downloaded engine plugin by another mini game is relatively high, thereby avoiding resource waste.

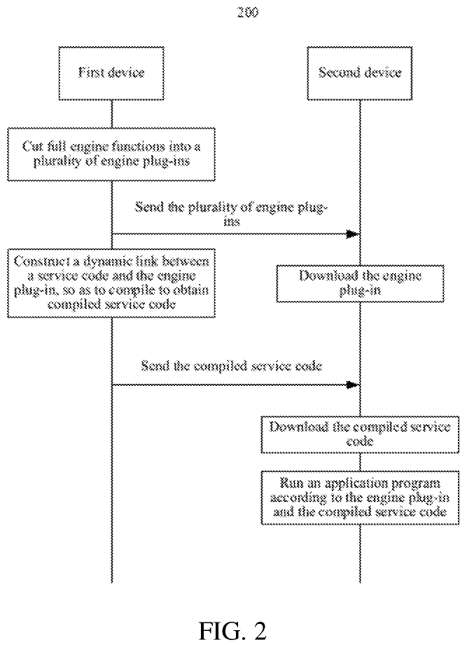

In some examples, refer to FIG. 2, which is a schematic diagram of an application program processing method according to an example of this application. As shown in 200 of FIG. 2, a first device divides full engine functions of an engine into a plurality of engine plugins, that is, deletes an unimportant part of the engine function and retains an important and reused part. For example, the first device provides the engine plugin to the second device, and the second device downloads the engine plugin. For example, after obtaining the service code, the first device constructs a dynamic link between the service code and the engine plugin, so as to compile to obtain compiled service code. The first device transmits the compiled service code to the second device. The second device downloads the compiled service code, and in a case that an engine plugin exists locally, runs the application program according to the locally existing engine plugin and the compiled service code, thereby implementing reuse of the engine code and increasing a cold start speed of the application program.

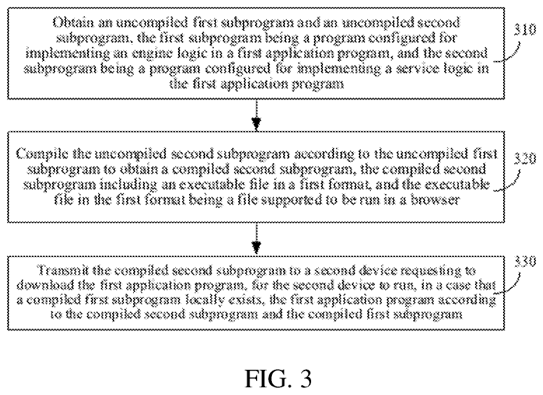

Refer to FIG. 3, which is a flowchart of an application program processing method according to an example of this application. Operations of the method may be performed by the first device described above, or a client of a compiling application program running in the first device. In the following method examples, for ease of description, only an execution body of each operation being a “computer device” is configured for description. The method may include at least one of the following operations (310-330).

Operation 310: Obtain an uncompiled first subprogram and an uncompiled second subprogram, the first subprogram being a program configured for implementing an engine logic in a first application program, and the second subprogram being a program configured for implementing a service logic in the first application program.

In some examples, the first application program is the target application program, that is, the first application program is any one of a VR game, an AR game, an FPS game, a multiplayer firearm survival game, a TPS game, a MOBA game, an SLG game, a social application program, and an interactive entertainment application program. The first application program in the example of this application is an application program obtained based on a game engine. A type of the game engine is not limited in this example of this application. For example, the game engine is at least one of an Unreal engine, Unity, and Cocos.

In some examples, the first application program may be an application program that needs to be downloaded and installed, or may be an application program that is ready for use (that is, the first application program can be used without the need to be installed, has features of click-to-play, installation-free, and light experience). For example, the first application program is a mini program.

In some examples, the uncompiled first subprogram refers to a program that implements an engine logic in the first application program. The engine logic herein refers to an engine function part that is in the engine and that provides a service for the first application program. For example, when writing service code, a developer calls many functions from an engine. That is, the service code includes a plurality of function names called from the engine, and a called engine function is referred to as an uncompiled first subprogram. The uncompiled first subprogram in the example of this application may include a program that implements an engine logic other than the engine logic in the first application program. That is, not only the engine function called by the service code is transmitted as the uncompiled first subprogram, but also full engine functions may be transmitted to the first device as uncompiled first subprograms.

In some examples, the engine is a game engine. For example, the engine includes at least one of a Unity engine, an Unreal Engine, and a Cocos engine. In some examples, the engine logic refers to a series of algorithms and decision procedures for processing tasks such as game core gameplay, a rule, physical simulation, AI behavior, input processing, and rendering scheduling inside an engine. These logics determine how the first application program responds to a player's input, how to update a game state, how to render a game picture, and the like.

In some examples, the engine function refers to an application programming interface (API) or a function library that is configured for implementing a specific function and that is provided by the engine. These functions are usually encapsulated with implementation details of an underlying technology, to provide a developer with a high-efficient and flexible development environment.

In some examples, the uncompiled second subprogram refers to a program configured for implementing a service logic in the first application program, that is, source code that is written by a developer for the first application program and that is related to a specific service logic. The service logic in this application is a logic for implementing a service to which the first application program points. For the first application program being a game application program, the service logic refers to a game logic, such as a location of a control displayed on an interface, a quantity of displayed controls, and operations of a game character.

In some examples, the first device is a device configured to compile the first application program. For example, the first device is a developer tool. The developer tool refers to an integrated development environment (IDE) that compiles and debugs the first application program. For example, a developer tool of the first application program may compile and debug the first application program. The first application program may be a mini game, a mini program, or the like. The developer tool is installed, stored, and run in the first device.

The first application program mentioned on the first device side of this example of this application is an application program in a code development process, and needs to be distinguished from an application program in a use process of a user.

In some examples, a developer writes code by using a third device, to develop the first application program. In some examples, original code, that is, the uncompiled code, of the first application program includes an uncompiled first subprogram and an uncompiled second subprogram.

In some examples, the first device obtains the uncompiled first subprogram and the uncompiled second subprogram from the third device. For example, a developer develops the first application program in the third device, to obtain the uncompiled first subprogram and the uncompiled second subprogram. For example, the third device transmits the uncompiled first subprogram and the uncompiled second subprogram to the first device. The third device is also referred to as an engine device, that is, a terminal device or a server in which an engine is located. For example, the third device and the first device are the same device, or may be different devices. In some examples, the third device is an engine IDE. The engine IDE refers to an IDE that develops the first application program, and may be installed, stored, and run in an engine device.

In some examples, when obtaining the first application program, the first device obtains the uncompiled first subprogram and the uncompiled second subprogram in parallel. In some examples, when obtaining the first application program, the first device serially obtains the uncompiled first subprogram and the uncompiled second subprogram. In some examples, full engine functions of the foregoing engine are locally stored in the first device, and the uncompiled first subprogram does not need to be repeatedly obtained from the third device. For example, the first device only needs to obtain call function indication information. For example, the call function indication information is configured for indicating an engine function called by the first application program. For example, the first device determines, in the locally stored full engine functions according to the call function indication information, the engine function called by the first application program, that is, determines the uncompiled first subprogram. For example, in this case, the first device only needs to obtain the call function indication information, and does not need to obtain the uncompiled first subprogram, thereby reducing a data volume that needs to be obtained, improving obtaining efficiency, and also improving subsequent compiling efficiency.

Operation 320: Compile the uncompiled second subprogram according to the uncompiled first subprogram to obtain a compiled second subprogram, the compiled second subprogram including an executable file in a first format, and the executable file in the first format being a file supported to be run in a browser.

In some examples, the uncompiled second subprogram is compiled in the first device according to the uncompiled first subprogram, to obtain the compiled second subprogram.

In some examples, the uncompiled first subprogram also needs to be compiled, to obtain the compiled first subprogram. However, this operation may be used as a pre-performed operation, and is completed in advance. Therefore, only one compiled second subprogram needs to be obtained herein, to increase a compiling speed. For example, for compiling of the uncompiled first subprogram, refer to the following operation 540 and operation 550, and the uncompiled first subprogram may be implemented as an uncompiled third subprogram or a part of the uncompiled third subprogram.

In some examples, the engine plugin mentioned in this application is a plugin configured for carrying an engine function. For example, the engine plugin is run in the second device. For example, the first device may encapsulate the engine function, to obtain the engine plugin. For example, the second device may run the engine plugin. For example, when the engine plugin runs in the second device, the engine function carried in the engine plugin is obtained. In some examples, a general engine function in an engine is encapsulated into an engine plugin, to provide the engine plugin to the second device, so that the second device reuses the engine function in the engine plugin without repeatedly downloading the same engine function.

In some examples, “compiling the uncompiled second subprogram according to the uncompiled first subprogram, to obtain the compiled second subprogram” mentioned in operation 320 may also be understood as processing the uncompiled second subprogram by using the uncompiled first subprogram, to obtain the processed second subprogram. The processed second subprogram is compiled to obtain the compiled second subprogram.

In some examples, a manner of processing the uncompiled second subprogram by using the uncompiled first subprogram is related to the uncompiled first subprogram. In some examples, a manner of processing the uncompiled second subprogram by using the uncompiled first subprogram is related to the uncompiled third subprogram. In some examples, a manner of processing the uncompiled second subprogram by using the uncompiled first subprogram is related to the uncompiled third subprogram and the uncompiled first subprogram.

In some examples, in a case that no engine plugin (that is, the uncompiled third subprogram) exists, the uncompiled first subprogram and the uncompiled second subprogram are linked in a static link manner, to obtain the processed second subprogram.

In some examples, in a case that the engine plugin exists, the engine plugin and the uncompiled second subprogram are linked in a dynamic link manner, to obtain the processed second subprogram.

In some examples, in a case that the engine plugin exists, the uncompiled first subprogram and the uncompiled second subprogram are linked in a static link manner, to obtain the processed second subprogram. The engine plugin and the uncompiled second subprogram are linked in a dynamic link manner, to obtain the processed second subprogram. For a specific implementation, refer to the following explanations and descriptions of the following examples.

In some examples, when the full engine functions are not cut but are all used as an engine plugin, the compiled second subprogram does not include an engine function in the engine plugin, that is, the compiled second subprogram completely does not include the engine functions.

In some other examples, when the full engine functions are cut, and a part of the full engine functions is used as the engine plugin, the compiled second subprogram does not include an engine function in the engine plugin, but may include an engine function other than the engine function in the engine plugin. That is, the compiled second subprogram does not completely include the engine functions.

In some examples, an engine function used as an engine plugin is found from the uncompiled first subprogram, a dynamic link is established between the engine function and the uncompiled second subprogram, and a part that is in the uncompiled first subprogram and that does not have an engine function used as an engine plugin is directly built in the uncompiled second subprogram. In some examples, two files may be obtained by means of compiling based on a dynamic link. In the example of this application, the code package is split by means of a dynamic link, to obtain the compiled second subprogram excluding the engine function in the engine plugin.

Both the uncompiled first subprogram and the uncompiled second subprogram in the example of this application are compiled into a file in a first format. For example, the compiled second subprogram includes an executable file in the first format. The file in the first format refers to a file that is allowed (or supported) to run in a browser. For example, the browser herein needs to be widely explained, that is, the browser includes a web browser and a browser-like program. When the browser is explained as a browser-like program, the browser-like program needs to include all programs similar to the browser. In some examples, the browser-like program is a click-to-use application program (for example, a mini program). For example, the first format is WASM. It is considered that in the related technology, when the uncompiled first subprogram and the uncompiled second subprogram are both files in the first format, when the two are compiled, an obtained compiling result is a complete file including the compiled first subprogram and the compiled second subprogram, and splitting cannot be implemented, resulting in that engine reuse cannot be implemented. When the technical solution provided in this example of this application is used, when the uncompiled first subprogram and the uncompiled second subprogram are both files in the first format, the compiled second subprogram may be obtained through compiling, that is, splitting of the engine and the service is implemented, thereby implementing engine reuse.

In some other examples, the uncompiled first subprogram, the uncompiled second subprogram, the compiled second subprogram, and the compiled first subprogram in this application may alternatively be files in another format. A type of the file is not limited in this application. For example, the file type is a JS format.

Operation 330: Transmit the compiled second subprogram to a second device requesting to download the first application program, for the second device to run, in a case that a compiled first subprogram locally exists, the first application program according to the compiled second subprogram and the compiled first subprogram.

In some examples, the compiled second subprogram is transmitted to the second device as an entire package. In some other examples, the compiled second subprogram is packetized and transmitted to the second device. In some other examples, when a data volume of the compiled second subprogram is greater than a second data volume, the compiled second subprogram is packetized and transmitted to the second device. When the data volume of the compiled second subprogram is not greater than the second data volume, the compiled second subprogram is transmitted to the second device as an entire package.

In some examples, a communication connection is directly established between the first device and the second device. When receiving a download request from the second device, the first device transmits the compiled second subprogram to the second device.

In some other examples, when the second device is a terminal device, the second device transmits a request for downloading the first application program to a server of the second device. For example, a communication connection is established between the first device and the server of the second device, and the compiled second subprogram obtained by compiling by the first device is directly transmitted to the server of the second device. For example, when the second device transmits a download request for the first application program to the server of the second device, the server of the second device transmits the compiled second subprogram transmitted by the first device to the second device.

In some other examples, a communication connection is not established between the first device and the server of the second device. However, the compiled second subprogram exported from the first device may be manually configured in the server. In some examples, when the second device transmits a request for downloading the first application program to the server of the second device, the server of the second device transmits the compiled second subprogram compiled by the first device to the second device.

In some examples, in addition to obtaining the compiled second subprogram by compiling, the first device further generates configuration information of the first application program, where the configuration information is transmitted to the second device, and the configuration information refers to information for configuring the first application program. For example, the configuration information includes an identifier and a version number of the first application program, a storage location of each subprogram in the first application program, a data volume of each subprogram, an identifier of each subprogram, a version number of each subprogram, and the like.

In some examples, the configuration information of the first application program includes attribute information of the compiled first subprogram and attribute information of the compiled second subprogram. The attribute information refers to information configured for representing an attribute of a file, such as an identifier of the file, a data volume of the file, and a version number of the file. The attribute information of the compiled first subprogram is configured for indicating an attribute of the compiled first subprogram, and the attribute information of the compiled second subprogram is configured for indicating an attribute of the compiled second subprogram.

In some examples, when the second device requests to download the first application program, both the compiled second subprogram and the configuration information of the first application program are transmitted to the second device.

In some examples, the second device determines, according to the attribute information of the compiled first subprogram, whether the compiled first subprogram exists locally. For example, the attribute information of the compiled first subprogram includes a version number of the compiled first subprogram, and the second device determines whether a compiled subprogram of this version locally exists, and if the compiled subprogram of this version exists, determines that the compiled first subprogram exists locally, or if the compiled subprogram of this version does not exist, determines that the compiled first subprogram does not exist locally. When the second device determines that the compiled first subprogram does not locally exist, the compiled first subprogram needs to be downloaded. In some examples, the second device directly obtains the compiled first subprogram from the first device. The second device may alternatively obtain the compiled first subprogram from the first device by using the server.

In the technical solution provided in the example of this application, the first device obtains an uncompiled first subprogram configured for implementing an engine logic and an uncompiled second subprogram configured for implementing a service logic, and compiles the uncompiled second subprogram by using the uncompiled first subprogram, to obtain a compiled second subprogram, where the compiled second subprogram includes an executable file in a first format. The uncompiled second subprogram is compiled by using the uncompiled first subprogram, to obtain the compiled second subprogram, so that unpackaging is implemented during compiling. When the second device requests to download the first application program, if the compiled first subprogram exists locally in the second device, the second device only needs to download the compiled second subprogram. Therefore, this application implements unpackaging of the engine logic and the service logic of the executable file of the first format, and in a case that the first subprogram configured for implementing the engine logic exists locally, the first subprogram does not need to be repeatedly downloaded. Therefore, in this application, reuse of the engine code (that is, the compiled first subprogram) can be implemented, and a download volume of the application program is reduced, thereby increasing a download speed of the application program.

A specific compiling procedure is described below as an example.

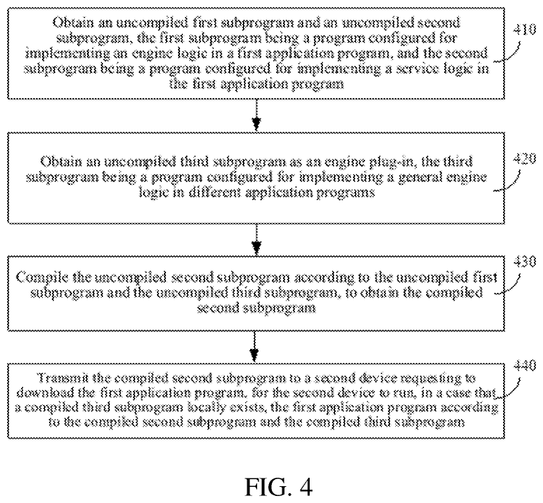

Refer to FIG. 4, which is a flowchart of an application program processing method according to another example of this application. Operations of the method may be performed by the first device described above, or a client of a compiling application program running in the first device. In the following method examples, for ease of description, only an execution body of each operation being a “computer device” is configured for description. The method may include at least one of the following operations (410-440).

Operation 410: Obtain an uncompiled first subprogram and an uncompiled second subprogram, the first subprogram being a program configured for implementing an engine logic in a first application program, and the second subprogram being a program configured for implementing a service logic in the first application program.

For technical details that are not mentioned in this example of this application, refer to explanations and descriptions of other examples in the context of this application. Details are not described herein.

Operation 420: Obtain an uncompiled third subprogram as an engine plugin, the third subprogram being a program configured for implementing a general engine logic in different application programs.

In some examples, the first device or another device integrates in advance general engine logics in full engine functions of an engine, to obtain at least one engine plugin. The general engine logic herein may be understood as a relatively general engine function, or may be understood as an engine function that most application programs need to call.

In some examples, whether an engine function is a general engine function may be pre-configured by a developer, or may be automatically determined according to a call status of the engine function.

In some examples, a developer preconfigures an engine function that is in the full engine functions and that belongs to a general engine function. In some other examples, an engine function whose call frequency is greater than or equal to a first value within a threshold time is determined as a general engine function. In some examples, an engine function whose call quantity is greater than or equal to a second value within a threshold time is determined as a general engine function. In some examples, if a quantity of application programs calling the engine function is greater than or equal to a third value within a threshold time, the engine function is determined as a general engine function.

In some examples, in a case that an engine function is a general engine function, the engine function is directly determined as an engine function included in the engine plugin. In some examples, in a case that an engine function is not a general engine function, the engine function is not determined as an engine function included in the engine plugin.

In some examples, one engine plugin corresponds to one uncompiled third subprogram. In some examples, one engine plugin may correspond to at least two uncompiled third subprograms.

In some examples, one uncompiled third subprogram includes one or at least two uncompiled general engine functions.

In some examples, on the first device side, it is considered that the engine function is included in the uncompiled third subprogram, and on the second device side, it is considered that the engine function is included in the engine plugin.

In some examples, there is at least one uncompiled third subprogram. For example, different uncompiled third subprograms include engine functions configured for implementing different general engine logics in the application program. For example, for an engine (for example, a first engine), general engine functions (engine functions commonly used by different application programs) of the engine are engine functions 1 to N (N is a positive integer), and the N engine functions may be set as one engine plugin, or may be set as a plurality of engine plugins. For example, if the N engine functions represent different functions, the N engine functions are divided into different engine plugins according to the functions.

In some examples, these uncompiled third subprograms all need to be compiled and then transmitted to the second device or the server of the second device, so as to be implemented on the second device as an engine plugin. For a specific obtaining and compiling procedure of the uncompiled third subprogram, references may be made to the following examples. Details are not described herein.

Operation 430: Compile the uncompiled second subprogram according to the uncompiled first subprogram and the uncompiled third subprogram, to obtain the compiled second subprogram.

In some examples, the uncompiled first subprogram represents a sum of engine functions that the first application program needs to call, and the uncompiled third subprogram represents a sum of engine functions that the second device may obtain from the engine plugin or a part thereof.

For example, in a process of compiling the uncompiled second subprogram according to the uncompiled first subprogram and the uncompiled third subprogram, to obtain the compiled second subprogram, a logic followed is as follows: If the called engine function is in the third subprogram, the called engine function may be obtained from the engine plugin. This part belongs to a general engine function, and does not need to be compiled in the second subprogram. Otherwise, if the called engine function is not in the third subprogram, the called engine function cannot be obtained from the engine plugin. In this case, to ensure starting of the application program, an engine function that cannot be obtained from the engine plugin needs to be compiled into the second subprogram.

In some examples, the uncompiled second subprogram is processed according to the uncompiled first subprogram and the uncompiled third subprogram, to obtain the processed second subprogram. In some examples, the processed second subprogram is compiled to obtain the compiled second subprogram.

For example, for an i^{th} engine function (i is a positive integer) that is called in the uncompiled second subprogram, a link is established between a location at which the i^{th} engine function is called in the uncompiled second subprogram and at least one of the uncompiled first subprogram and the uncompiled third subprogram. For example, for the i^{th} engine function called in the uncompiled second subprogram, a link is established between the location at which the i^{th} engine function is called in the uncompiled second subprogram and the i^{th} engine function in the uncompiled first subprogram. For example, for the i^{th} engine function called in the uncompiled second subprogram, a link is established between the location at which the i^{th} engine function is called in the uncompiled second subprogram and the i^{th} engine function in the uncompiled third subprogram. For example, for the i^{th} engine function called in the uncompiled second subprogram, a link is established between the location at which the i^{th} engine function is called in the uncompiled second subprogram and both the i^{th} engine function in the uncompiled first subprogram and the i^{th} engine function in the uncompiled third subprogram.

In some examples, priority information of the first application program is obtained, where the priority information is configured for indicating a priority of the first application program. For example, in a process of developing the first application program by using the third device, a priority is set for the first application program at the same time. For example, the first device obtains the priority information of the first application program from the third device. For example, if the priority of the first application program is higher, the first application program is more important. For example, a lower priority of the first application program indicates that the first application program is relatively unimportant.

In some examples, in a case that it is determined, according to the priority information of the first application program, that the priority of the first application program is higher than or equal to a first priority, for the i^{th} engine function called in the uncompiled second subprogram, a link is established between the location at which the i^{th} engine function is called in the uncompiled second subprogram and the i^{th} engine function in the uncompiled first subprogram. In addition, a link is established between the location at which the i^{th} engine function is called in the uncompiled second subprogram and the i^{th} engine function in the uncompiled third subprogram. Specifically, for the i^{th} engine function called in the uncompiled second subprogram, a static link is established between the location at which the i^{th} engine function is called in the uncompiled second subprogram and the i^{th} engine function in the uncompiled first subprogram. In addition, a dynamic link is established between the location at which the i^{th} engine function is called in the uncompiled second subprogram and the i^{th} engine function in the uncompiled third subprogram. In this manner, it is ensured that a function call succeeds and program running efficiency is improved by using two function linking manners.

In some examples, in a case that it is determined, according to the priority information of the first application program, that the priority of the first application program is lower than a second priority, for the i^{th} engine function called in the uncompiled second subprogram, a link is established between the location at which the i^{th} engine function is called in the uncompiled second subprogram and the i^{th} engine function in the uncompiled first subprogram. Alternatively, a link is established between the location at which the i^{th} engine function is called in the uncompiled second subprogram and the i^{th} engine function in the uncompiled third subprogram. In this manner, a relationship between importance of an application program and a download volume is balanced by selecting only one function linking manner. Invoking efficiency is ensured as much as possible, and too large download volume is not caused.

In some examples, the first priority is greater than or equal to the second priority. In some examples, the first priority and the second priority are preset by a developer.

According to the technical solution provided in this example of this application, the uncompiled third subprogram configured for implementing the general engine logic in different application programs is obtained, and the uncompiled second subprogram is compiled by jointly using the uncompiled third subprogram and the uncompiled first subprogram, thereby improving flexibility and diversity of compiling manners of the uncompiled second subprogram, and facilitating improving a compiling effect of service logic code.

In some examples, for each engine function called in the uncompiled second subprogram in a case that the engine function exists in the uncompiled third subprogram, a dynamic link is constructed at a location at which the engine function is called in the uncompiled second subprogram, the dynamic link being configured for linking the location at which the engine function is called in the uncompiled second subprogram with the engine function in a compiled third subprogram.

For example, in a process of dynamic linking, content to be linked is not linked in, but in an execution process, content to be linked is searched for again, and a generated executable file does not have the content to be linked. Therefore, when a dynamic library is deleted, an executable program cannot run. For example, when the engine plugin does not exist locally, the compiled second subprogram cannot be successfully run. Therefore, whether the compiled first subprogram or the compiled third subprogram exists locally needs to be determined in advance. If the engine plugin does not exist locally, the engine plugin needs to be downloaded, to ensure successful starting of the application program.

In some examples, in a case that a dynamic link is constructed at the location at which the engine function is called in the uncompiled second subprogram, the second device obtains the engine function from the compiled third subprogram when running the compiled second subprogram.

For example, when the second device runs the compiled second subprogram, due to configuration of the dynamic link, the second device obtains the engine function from the locally existing compiled third subprogram. That is, the second device obtains the engine function from a local engine plugin. For example, a symbol (configured for indicating an engine function) of a to-be-linked engine function is configured in the dynamic link. For example, when the second device runs the compiled second subprogram, according to the symbol of the to-be-linked engine function configured in the dynamic link, the second device searches local internal memory space (storing the downloaded engine plugin) for an engine function matching the symbol, and calls the engine function in a case that the engine function matching the symbol is found.

For example, the location at which the engine function is called in the uncompiled second subprogram is linked to the engine function in the compiled third subprogram in a dynamic link manner, so that a data volume of the compiled second subprogram can be reduced. Because the engine function in this case is not truly written into the executable file, a data volume of the executable file is relatively small.

In some examples, in a case that the engine function does not exist in the uncompiled third subprogram and exists in the uncompiled first subprogram, a static link is constructed at the location at which the engine function is called in the uncompiled second subprogram, the static link being configured for building the engine function in the uncompiled first subprogram at the location at which the engine function is called in the uncompiled second subprogram.

For example, a process of static linking means that content to be linked is already linked to a generated executable file, and execution of the executable program is not affected even if a static library is deleted. That is, the engine function in the uncompiled first subprogram is built at the location at which the engine function is called in the uncompiled second subprogram. This manner is for those engine functions that are cut, that is, engine functions that are not used as a public part. Because the engine functions are not included in the engine plugin, the engine functions need to be separately built in. This is also to ensure successful starting of the application program while reducing a data volume of the executable file as much as possible.

For example, when the second device runs the compiled second subprogram, because of configuration of the static link, the linked engine function is already built in the compiled second subprogram. In this case, the engine function is already implemented as a part of the compiled second subprogram. That is, the second device obtains the engine function from the compiled second subprogram.

In some examples, each engine function called in the uncompiled second subprogram is traversed, to construct the dynamic link or the static link, and obtain a processed second subprogram.

In some examples, each engine function called in the uncompiled second subprogram is traversed according to a location order of code. In some examples, a quantity of engine functions called in the uncompiled second subprogram is M. In some examples, after the dynamic link or the static link is constructed for the i^{th} engine function, a dynamic link or a static link is constructed for an (i+1)^{th} engine function. For example, i is a positive integer less than M. In some examples, for at least two engine functions, a dynamic link or a static link is separately constructed at the same time.

In some examples, the static link refers to a process of linking all library code required by a program to a single executable file during compiling. This means that the entire library code becomes a part of the executable file. A linker integrates code of all libraries and code of the program into an independent executable file. During running, the program does not need to separately access the library code because the library code already exists in the executable file.

In some examples, the dynamic link refers to a process of linking library code to an executable file during running. This means that the library code is not a part of an executable file, but is separately stored as a shared library file (for example, a .dll file in Windows, or a .so file in Linux). The program dynamically accesses these shared library files during running. This is usually implemented by using a dynamic linker, which resolves a symbol reference and maps library code to internal memory space of a program when the program is loaded.

For example, for each engine function called in the uncompiled second subprogram, the foregoing operation of constructing the dynamic link or the static link is performed, to obtain the processed second subprogram.

In some examples, the processed second subprogram is compiled to obtain the compiled second subprogram.

For example, after the uncompiled second subprogram is processed, a compiling function of the first device is called to compile the uncompiled second subprogram, to obtain the executable file in the first format, that is, the compiled second subprogram.

In some examples, in a case that a static link is constructed at the location at which the engine function is called in the uncompiled second subprogram, the second device obtains the engine function from inside the compiled second subprogram when running the compiled second subprogram.

In some examples, the first device compiles the uncompiled second subprogram by using a compiler, to obtain the compiled second subprogram.

For example, GameAssembly.bc (that is, service code, which may also be understood as an uncompiled second subprogram), UnityEngine.bc (full engine code), and UnityEngine.wechat.plugin.wasm (uncompiled third subprogram, which may alternatively be understood as an engine plugin) are inputted to the compiler. For example, the compiler uses an instruction emcc-s MAIN_MODULE GameAssembly.bc GameAssembly.wasm to compile the uncompiled second subprogram. For example, emcc in the instruction may be understood as a compiler, s MAIN_MODULE may be understood as an uncompiled third subprogram used as an engine plugin, and GameAssembly.wasm may be understood as a compiled second subprogram.

The full engine code herein may be understood as full engine functions, and the full engine functions include the uncompiled first subprogram. The full engine functions may be inputted to the compiler herein, or only the uncompiled first subprogram may be inputted.

In some examples, by using the service code as “main”, it is determined which engine function needs to be called in the service code. First, it is determined whether there is such an engine function in the wechat.plugin.wasm module (that is, first, it is determined whether there is such a function in the uncompiled third subprogram). If there is such a function in the wechat.plugin.wasm module, references are made by using a dynamic link (during running, the function is found in the plugin). If there is no such a function in wechat.plugin.wasm, UnityEngine.bc is searched for the function, and a static link is configured for reference (the function is directly connected to outputted wasm), that is, the engine function is directly built in the compiled second subprogram.

In some examples, after compiling, unity.wasm (a compiled second subprogram, including a service function, and also including some engine functions not shared with other applications) and UnityEngine.wechat.plugin.wasm (which may be understood as a compiled third subprogram or engine plugin), including an engine function as a public part are outputted. Output of the second branch herein may be compiled in advance. That is, when the uncompiled second subprogram is compiled, compiling of the uncompiled third subprogram is completed. The uncompiled third subprogram does not need to be compiled again, and the compiled second subprogram is directly outputted.

In the technical solution provided in this example of this application, for the engine function called in the second subprogram, in a case that the engine function exists in the engine plugin, a dynamic link is constructed, and when the engine function does not exist in the engine plugin, a static link is constructed, reflecting diversity of obtaining manners of the engine function during compiling. In addition, in the manner of the dynamic link, an engine function in a locally downloaded engine plugin can be maximally reused, utilization of the engine plugin is improved, and a static link is constructed to ensure stable running of the compiled second subprogram.

Operation 440: Transmit the compiled second subprogram to a second device requesting to download the first application program, for the second device to run, in a case that a compiled third subprogram locally exists, the first application program according to the compiled second subprogram and the compiled third subprogram.

In some examples, when operation 320 is implemented as operation 420 or operation 430, operation 330 may be implemented as operation 440. That is, whether an engine plugin exists locally is determined, and if the engine plugin exists locally, the engine plugin existing locally is directly reused. The engine plugin is downloaded if the engine plugin does not exist.

The methods for splitting the engine function to obtain the engine plugin and how to unpackage and transmit the compiled second subprogram are described below as an example.

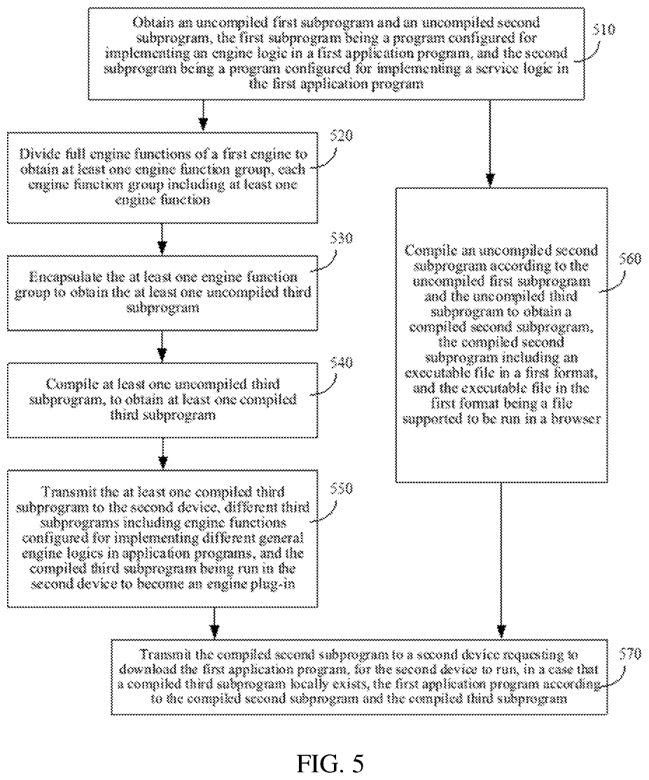

Refer to FIG. 5, which is a flowchart of an application program processing method according to an example of this application. Operations of the method may be performed by the first device described above, or a client of a compiling application program running in the first device. In the following method examples, for ease of description, only an execution body of each operation being a “computer device” is configured for description. The method may include at least one of the following operations (510-570).

Operation 510: Obtain an uncompiled first subprogram and an uncompiled second subprogram, the first subprogram being a program configured for implementing an engine logic in a first application program, and the second subprogram being a program configured for implementing a service logic in the first application program.

Operation 520: Divide full engine functions of a first engine to obtain at least one engine function group, each engine function group including at least one engine function.

In some examples, the first engine is determined according to a service type of the first application program. The first engine may be an engine that is most used among a plurality of engines supporting the first application program.

In some examples, each engine has its own engine function library, and full engine functions of the engine are stored in the engine function library.

In some examples, an engine device divides full engine functions of a first engine, to obtain at least one engine function group. For example, at least one engine function group corresponds to at least one engine plugin UnityEngine_CoreModule.wasm. In some examples, when the engine divides the engine functions, a division result is as follows:
WebGLSupport_AIModule_Dynamic.a;
WebGLSupport_AccessibilityModule_Dynamic.a;
WebGLSupport_AndroidJNIModule_Dynamic.a;
WebGLSupport_AnimationModule_Dynamic.a;
WebGLSupport_AssetBundleModule_Dynamic.a;
WebGLSupport_AudioModule_Dynamic.a;
WebGLSupport_AutoStreamingModule_Dynamic.a;
WebGLSupport_ClothModule_Dynamic.a;
WebGLSupport_CoreModule_Dynamic.a;
WebGLSupport_CrashReportingModule_Dynamic.a;
WebGLSupport_DSPGraphModule_Dynamic.a;
WebGLSupport_DirectorModule_Dynamic.a;
WebGLSupport_GIModule_Dynamic.a;
WebGLSupport_GameCenterModule_Dynamic.a;
WebGLSupport_GridModule_Dynamic.a;
WebGLSupport_HotReloadModule_Dynamic.a;
WebGLSupport_IMGUIModule_Dynamic.a;
WebGLSupport_ImageConversionModule_Dynamic.a;
WebGLSupport_InputLegacyModule_Dynamic.a;
WebGLSupport_InputModule_Dynamic.a;
WebGLSupport_JSONSerializeModule_Dynamic.a;
WebGLSupport_LocalizationModule_Dynamic.a;
WebGLSupport_ParticleSystemModule_Dynamic.a;
WebGLSupport_PerformanceReportingModule_Dynamic.a;
WebGLSupport_Physics2DModule_Dynamic.a;
WebGLSupport_PhysicsModule_Dynamic.a;
WebGLSupport_ProfilerModule_Dynamic.a;
WebGLSupport_RuntimeInitializeOnLoadManagerInitializerModule_Dynamic.a;
WebGLSupport_ScreenCaptureModule_Dynamic.a;
WebGLSupport_SharedInternalsModule_Dynamic.a;
WebGLSupport_SpriteMaskModule_Dynamic.a;
WebGLSupport_SpriteShapeModule_Dynamic.a;
WebGLSupport_StreamingModule_Dynamic.a;
WebGLSupport_SubstanceModule_Dynamic.a;
WebGLSupport_SubsystemsModule_Dynamic.a;
WebGLSupport_TLSModule_Dynamic.a;
WebGLSupport_TerrainModule_Dynamic.a;
WebGLSupport_TerrainPhysicsModule_Dynamic.a;
WebGLSupport_TextCoreFontEngineModule_Dynamic.a;
WebGLSupport_TextCoreTextEngineModule_Dynamic.a;
WebGLSupport_TextRenderingModule_Dynamic.a;
WebGLSupport_TilemapModule_Dynamic.a;
WebGLSupport_UIElementsModule_Dynamic.a;
WebGLSupport_UIElementsNativeModule_Dynamic.a;
WebGLSupport_UIModule_Dynamic.a;
WebGLSupport_UIWidgetsModule_Dynamic.a;
WebGLSupport_UNETModule_Dynamic.a;
WebGLSupport_UmbraModule_Dynamic.a;
WebGLSupport_UnityAnalyticsCommonModule_Dynamic.a;
WebGLSupport_UnityAnalyticsModule_Dynamic.a;
WebGLSupport_UnityConnectModule_Dynamic.a;
WebGLSupport_UnityCurlModule_Dynamic.a;
WebGLSupport_UnityTestProtocolModule_Dynamic.a;
WebGLSupport_UnityWebRequestAssetBundleModule_Dynamic.a;
WebGLSupport_UnityWebRequestAudioModule_Dynamic.a;
WebGLSupport_UnityWebRequestModule_Dynamic.a;
WebGLSupport_UnityWebRequestTextureModule_Dynamic.a;
WebGLSupport_UnityWebRequestWWWModule_Dynamic.a;
WebGLSupport_VFXModule_Dynamic.a;
WebGLSupport_VRModule_Dynamic.a;
WebGLSupport_VehiclesModule_Dynamic.a;
WebGLSupport_VideoModule_Dynamic.a;
WebGLSupport_WebGLModule_Dynamic.a;
WebGLSupport_WindModule_Dynamic.a;
WebGLSupport_XRModule_Dynamic.a.

For example, the foregoing modules respectively correspond to one engine function group, and each engine function group includes at least one engine function. For example, the engine device transmits the at least one engine function group to the first device, and the first device performs compiling, to obtain at least one compiled third subprogram.

According to the technical solution provided in this example of this application, the full engine functions of the first engine may be divided to obtain the engine function group and the uncompiled third subprogram (which is implemented as the engine plugin) is obtained through encapsulation, so that the engine plugins finally run on the second device are diversified and flexible. The second device may load the engine plugin as required, without worrying about a large data volume of the engine plugin.

In some examples, the full engine functions are divided according to function types of engine functions in the full engine functions, to obtain at least one engine function group.

For example, the function type of the engine function refers to a type of a function implemented by the engine function. For example, the function type of the engine function includes at least one of the following: engine starting, engine exit, data exchange, data filtering, data aggregation, data sorting, and the like. For example, the first device or a developer of the first device analyzes function types of engine functions in the full engine functions, and divides the full engine functions according to the function types. Further, an infrequently used engine function is deleted, to obtain at least one engine function group. For example, one engine function group corresponds to one function type. When the engine function group is divided according to function types, different engine plugins correspond to different functions. If an engine plugin represents an engine function required for starting an engine, the engine plugin needs to have a highest priority, and be downloaded first.

In some other examples, the full engine functions are divided according to use frequencies of the engine functions in the full engine functions, to obtain at least one engine function group.

For example, the full engine functions are divided without considering the function type, but considering only the use frequency.

For example, the use frequency of the engine function refers to a frequency at which the engine function is called in a process of developing different application programs. In some examples, a higher use frequency of an engine function indicates better universality of the engine function. Otherwise, a lower use frequency of an engine function indicates poorer universality of the engine function.

For example, the full engine functions are divided according to different use frequency ranges, to obtain at least one engine function group. One engine function group corresponds to one use frequency interval. According to the technical solution provided in the example of this application, full engine functions are divided according to function types of the engine functions or use frequencies of the engine functions, so that division manners of the engine functions are diversified, and the engine functions can be divided according to different requirements, to obtain different engine plugins.

For example, a plurality of application programs based on the first engine are run, and use frequency of each engine function in the full engine functions is determined. Engine functions whose use frequencies are greater than a threshold are selected, to obtain at least one engine function group.

For example, first, all engine functions whose use frequencies are greater than a threshold are selected, and then these selected engine functions are divided into at least one engine function group again according to use frequencies. For example, engine functions whose use frequencies are greater than a first threshold are used as a first engine function group. For example, engine functions whose use frequencies are not greater than the first threshold but are greater than a second threshold are used as a second engine function group. For example, engine functions whose use frequencies are not greater than the second threshold but are greater than a third threshold are used as a third engine function group, and so on. The first threshold is greater than the second threshold which is greater than the third threshold. For example, a priority of a first engine plugin corresponding to the first engine function group is greater than a priority of a second engine plugin corresponding to the second engine function group, which is greater than a priority of a third engine plugin corresponding to the third engine function group. The priority herein represents a download priority. If an engine function in an engine plugin has a higher use frequency, download of the engine plugin can basically support starting or running of the application program. Specific values of the threshold, the first threshold, the second threshold, and the third threshold are not limited in this example of this application.

According to the technical solution provided in this example of this application, engine functions whose use frequencies are greater than a threshold are selected, to obtain at least one engine function group. This is beneficial to quickly selecting an engine function configured for implementing a general engine logic from full engine functions, thereby increasing a screening speed and screening accuracy of the engine function configured for implementing the general engine logic, and further improving determining efficiency of an engine plugin.

Operation 530: Encapsulate the at least one engine function group to obtain the at least one uncompiled third subprogram.

In some examples, function encapsulation refers to packaging a segment of code into an independent function unit, so as to be repeatedly called when needed. For example, reusability, readability, and maintainability of code can be improved through encapsulation.

In some examples, at least one of operation 520 to operation 550 is a pre-performed operation. At least one of operation 520 to operation 550 may be performed by the first device before the first device transmits the compiled second subprogram to the second device requesting to download the first application program.

Operation 540: Compile at least one uncompiled third subprogram, to obtain at least one compiled third subprogram.

In some examples, the at least one uncompiled third subprogram is separately compiled by using a compiling device, to obtain at least one compiled third subprogram. In some examples, the at least one uncompiled third subprogram is separately compiled by using the first device, to obtain at least one compiled third subprogram. In some examples, a compiler in the first device is configured for compiling the at least one uncompiled third subprogram, to obtain at least one compiled third subprogram.

In some examples, when the uncompiled first subprogram is expected to be implemented as an engine plugin, the first subprogram and the third subprogram have the same meaning, and both include an engine function that can become an engine plugin after being compiled.

Operation 550: Transmit the at least one compiled third subprogram to the second device, different third subprograms including engine functions configured for implementing different general engine logics in application programs, and the compiled third subprogram being run in the second device to become an engine plugin.

In some examples, the first device transmits the at least one compiled third subprogram to the second device when the second device requests to download an engine plugin. In some examples, an engine plugin has identification information, and different engine plugins have different identification information. In some examples, a correspondence table is established between the identification information and the compiled third subprogram. In some examples, the correspondence table stores a correspondence between at least one group of identification information and the compiled third subprogram.

In some examples, when the second device requests to download the engine plugin from the server, the server transmits the at least one compiled third subprogram to the second device. The server prestores at least one compiled third subprogram from the first device.

In some examples, a compiled third subprogram corresponding to identification information is determined in at least one compiled third subprogram according to the identification information carried in a download request transmitted by the second device. For example, the compiled third subprogram corresponding to the identification information is transmitted to the second device. In some examples, the first device determines, from the correspondence table according to the identification information carried in the download request transmitted by the second device, the compiled third subprogram corresponding to the identification information. For example, the compiled third subprogram corresponding to the identification information is transmitted to the second device.

In the technical solution provided in this example of this application, the second device transmits the compiled third subprogram, so that engine code configured for implementing the general engine logic is implemented as an engine plugin in the second device. Specifically, the compiled third subprogram may be transmitted to the second device before the second device requests to download the first application program, or when the second device requests to download the first application program. Therefore, the manner of transmitting the compiled third subprogram is beneficial to ensuring that the engine plugin runs on the second device, thereby ensuring that the first application program runs smoothly.

Operation 560: Compile an uncompiled second subprogram according to the uncompiled first subprogram and the uncompiled third subprogram to obtain a compiled second subprogram, the compiled second subprogram including an executable file in a first format, and the executable file in the first format being a file supported to be run in a browser.

Operation 570: Transmit the compiled second subprogram to a second device requesting to download the first application program, for the second device to run, in a case that a compiled third subprogram locally exists, the first application program according to the compiled second subprogram and the compiled third subprogram.

In some examples, at least one first function configured for starting the first application program is selected from functions included in the compiled second subprogram.

In some examples, the first function is a function configured for starting the first application program. For example, the first function is a function that is included in the compiled second subprogram and that is configured for implementing a starting function of the first application program.

In some examples, the first device selects, according to a function type of each function in the compiled second subprogram, a function whose function type is a starting function, and uses the function as the at least one first function for starting the first application program. In some examples, a quantity of first functions is not limited. For example, there is at least one first function.

In some examples, the at least one first function is packaged and transmitted to the second device.

For example, without considering a data volume of the compiled second subprogram, the at least one first function configured for starting the first application program is selected from functions included in the compiled second subprogram, and these first functions are packaged and transmitted to the second device.

For example, when the data volume of the compiled second subprogram is considered, at least one first function configured for starting the first application program is selected from functions included in the compiled second subprogram, and these first functions are packaged and transmitted to the second device. For example, when the data volume of the compiled second subprogram is less than or equal to a second data volume, the second subprogram is not packetized and transmitted. For example, when the data volume of the compiled second subprogram is greater than the second data volume, at least one first function configured for starting the first application program is selected from functions included in the compiled second subprogram, and these first functions are packaged and transmitted to the second device.

For example, the compiled second subprogram is packaged except the first function, and is also transmitted to the second device. Certainly, the code package is transmitted after a code package in which the first function is located.

According to the technical solution provided in the example of this application, on the basis of reusing the engine function, the compiled second subprogram is unpackaged, and the function configured for starting the first application program is first transmitted, thereby further reducing the initial download volume, and effectively increasing a cold starting speed of the application program.

In addition, in this example of this application, full engine functions are cut, an unimportant part is removed, and a public part that is reserved through cutting and that is configured for representing a general engine logic is compiled into at least one compiled third subprogram, so as to be implemented as at least one engine plugin. In this manner, a reuse rate of the engine function in the engine plugin is ensured as much as possible, and a download volume of the executable file is considered.

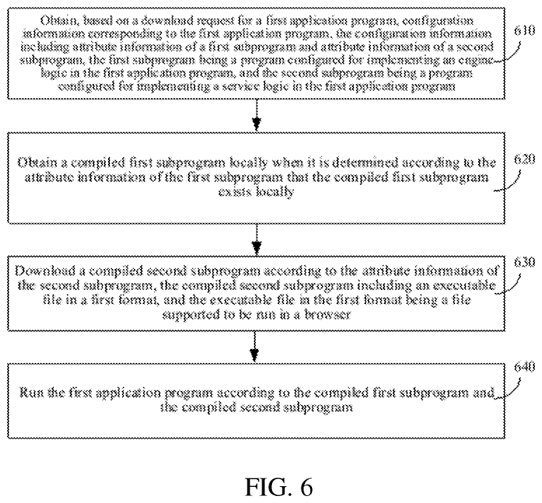

Refer to FIG. 6, which is a flowchart of an application program processing method according to another example of this application. Operations of the method may be performed by the second device described above. In the following method examples, for ease of description, only an execution body of each operation being a “computer device” is configured for description. The method may include at least one of the following operations (610-640).

Operation 610: Obtain, based on a download request for a first application program, configuration information corresponding to the first application program, the configuration information including attribute information of a first subprogram and attribute information of a second subprogram, the first subprogram being a program configured for implementing an engine logic in the first application program, and the second subprogram being a program configured for implementing a service logic in the first application program.

In some examples, the configuration information is information related to a first application program requested to be downloaded. For example, the configuration information includes the attribute information of the first subprogram and the attribute information of the second subprogram.

In some examples, the attribute information of the first subprogram is information related to an attribute of an engine used by the first application program. In some examples, the attribute information of the second subprogram is information related to an attribute of the first application program. In some examples, the attribute information includes a version number and an identifier. For example, the first device separately generates a version number and an identifier for each engine plugin. For example, the first device generates a version number and an identifier for the compiled second subprogram.

For example, when the first subprogram is implemented as an engine plugin, the configuration information includes the attribute information of the first subprogram and the attribute information of the second subprogram.

For example, when the first subprogram cannot be implemented as an engine plugin, the configuration information includes attribute information of a called engine plugin (a third subprogram) and the attribute information of the second subprogram.

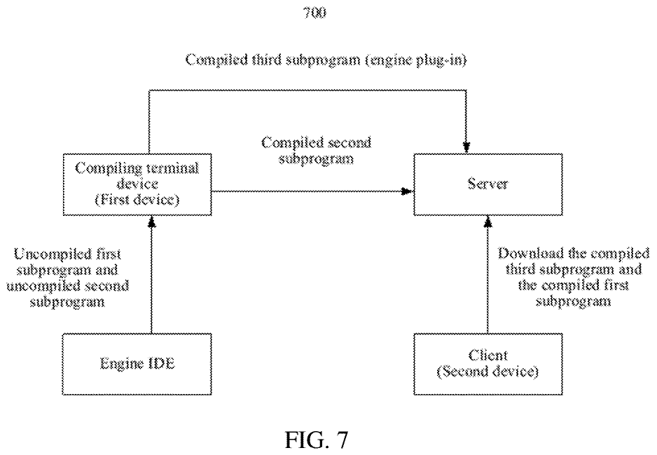

In some examples, refer to FIG. 7, which is a block diagram of an application program processing method according to an example of this application. As shown in FIG. 7, an engine IDE transmits both an uncompiled first subprogram and an uncompiled second subprogram to a compiling terminal device. The compiling terminal device compiles the uncompiled second subprogram according to the compiled third subprogram and the uncompiled first subprogram, to obtain the compiled second subprogram. For example, the compiling terminal device transmits the compiled second subprogram to the server. When the client requests to download the first application program, the client determines whether the compiled third subprogram (that is, the engine plugin) locally exists. If the compiled third subprogram exists, only the compiled second subprogram is downloaded. If the compiled third subprogram does not exist, the compiled second subprogram and the compiled third subprogram need to be downloaded. Certainly, when the compiled first subprogram can also be independently implemented as an engine plugin, when the client requests to download the first application program, whether the compiled first subprogram (that is, the engine plugin) locally exists is determined. If the compiled first subprogram exists, only the compiled second subprogram is downloaded. If the compiled first subprogram does not exist, the compiled second subprogram and the compiled first subprogram need to be downloaded.

Operation 620: Obtain a compiled first subprogram locally when it is determined according to the attribute information of the first subprogram that the compiled first subprogram exists locally.

In some examples, when the uncompiled first subprogram includes full engine functions, and the compiled first subprogram is implemented as an engine plugin, when it is determined according to the attribute information of the first subprogram that the compiled first subprogram locally exists, the compiled first subprogram is obtained locally.

In some examples, when it is determined according to the attribute information of the first subprogram that the compiled first subprogram does not locally exist, the compiled first subprogram is obtained from the server.

In some examples, the attribute information of the first subprogram includes an identifier and version information of the first subprogram. A compiled first subprogram corresponding to the identifier of the first subprogram is searched for according to the identifier of the first subprogram.

In some examples, the identifier of the first subprogram is matched against local reference identifiers one by one. When a reference identifier consistent with the identifier of the first subprogram locally exists, a compiled first subprogram corresponding to the identifier of the first subprogram locally exists.

In some examples, when a reference identifier consistent with the identifier of the first subprogram does not locally exist, the compiled first subprogram corresponding to the identifier of the first subprogram does not locally exist. Generally, each file has a corresponding identifier. The identifier of the first subprogram is matched against local reference identifiers of all files one by one. When a reference identifier consistent with the identifier of the first subprogram locally exist, the compiled first subprogram corresponding to the identifier of the first subprogram locally exists. When the reference identifier consistent with the identifier of the first subprogram does not locally exist, the compiled first subprogram corresponding to the identifier of the first subprogram does not locally exist.

In some examples, when it is found that the compiled first subprogram corresponding to the identifier of the first subprogram locally exists, it is detected whether version information of the local compiled first subprogram is the same as version information in the attribute information of the first subprogram. The version information in the attribute information of the first subprogram may be the version number of the compiled first subprogram. The same first subprogram may have different version information. First subprograms of different version information have a particular difference.

In some examples, when the version information of the local first subprogram is the same as the version information in the attribute information of the first subprogram, the compiled first subprogram is obtained locally. When the version information of the local compiled first subprogram is the same as the version information in the attribute information of the first subprogram, the local compiled first subprogram is an engine plugin that is called in the first application program, and the compiled first subprogram is obtained locally.

In some examples, when the uncompiled first subprogram does not include full engine functions, or the compiled first subprogram is not implemented as an engine plugin, the attribute information of the first application program herein needs to be understood as attribute information of an engine plugin called by the first application program, that is, an attribute of the foregoing compiled third subprogram.

For example, when it is determined, according to the attribute information of the called engine plugin, that the compiled third subprogram locally exists, the compiled third subprogram is obtained locally. The compiled third subprogram is obtained from the server when it is determined, according to the attribute information of the called engine plugin, that the compiled third subprogram does not locally exist.

In some examples, when the attribute information of the called engine plugin includes an identifier and version information of the called engine plugin, it is searched, according to the identifier of the called engine plugin, whether the compiled third subprogram corresponding to the called engine plugin locally exists. The identifier of the called engine plugin is configured for uniquely identifying the called engine plugin.

In some examples, the identifier of the called engine plugin is matched against local reference identifiers one by one. When a reference identifier consistent with the identifier of the called engine plugin exists locally, a compiled third subprogram corresponding to the identifier of the called engine plugin exists locally.

In some examples, when the reference identifier consistent with the identifier of the called engine plugin does not locally exist, the compiled third subprogram corresponding to the identifier of the called engine plugin does not locally exist. Generally, each file has a corresponding identifier. The identifier of the called engine plugin is matched against local reference identifiers of all files one by one. When a reference identifier consistent with the identifier of the called engine plugin exists locally, a compiled third subprogram corresponding to the identifier of the called engine plugin exists locally. When the reference identifier consistent with the identifier of the called engine plugin does not locally exist, the compiled third subprogram corresponding to the identifier of the called engine plugin does not locally exist.

In some examples, when it is found that the compiled third subprogram corresponding to the identifier of the called engine plugin locally exists, it is detected whether version information of the local compiled third subprogram is the same as the version information in the attribute information of the called engine plugin. The version information in the attribute information of the called engine plugin may be the version number of the compiled third subprogram. The same third subprogram may have different version information. Third subprograms of different version information have a particular difference.

In some examples, when the version information of the local compiled third subprogram is the same as the version information in the attribute information of the called engine plugin, the compiled third subprogram is obtained locally. When the version information of the local compiled third subprogram is the same as the version information in the attribute information of the called engine plugin, the local compiled third subprogram is the engine plugin that is called in the first application program, and the compiled third subprogram is obtained locally.

In some examples, when the compiled first subprogram is downloaded, a first data volume of the downloaded compiled first subprogram is obtained. The data volume refers to a data size of a file, such as 8 bytes (8 B), 10 megabytes (10 MB), or 20 gigabytes (20 GB). The first data volume is a data size of the compiled first subprogram.

In some examples, when the compiled first subprogram or the compiled third subprogram is downloaded, the compiled first subprogram or the compiled third subprogram is packetized and downloaded based on the data volume.

In some other examples, when version information of a local first subprogram is different from the version information in the attribute information of the first subprogram, incremental data corresponding to the local compiled first subprogram is downloaded, where the incremental data is obtained by calculating a difference between the compiled first subprogram corresponding to the attribute information of the first subprogram and the local first subprogram.

In some other examples, when version information of a local third subprogram is different from the version information in the attribute information of the called engine plugin, incremental data corresponding to the local compiled third subprogram is downloaded, where the incremental data is obtained according to a difference between the compiled third subprogram corresponding to the attribute information of the called engine plugin and the local compiled third subprogram.

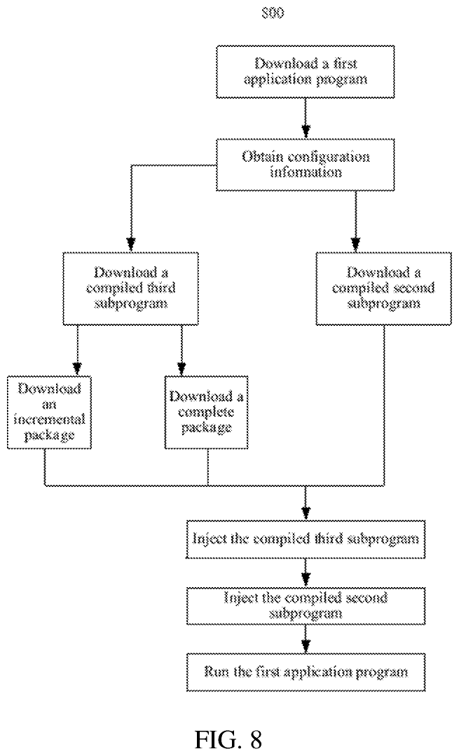

In some examples, refer to FIG. 8, which is a block diagram of an application program processing method according to another example of this application. As shown in 800 of FIG. 8, after transmitting a download request for a first application program, a second device obtains configuration information of a first application program. A compiled second subprogram is downloaded according to the configuration information, and it is determined whether a compiled third subprogram exists locally. For example, when an engine plugin having completely the same version information and identifier locally exists, the local engine plugin is directly reused. For example, when an engine plugin having the same identifier but different version information locally exists, an incremental package (incremental data) of the engine plugin is downloaded. For example, when no engine plugin having a consistent identifier locally exists, a complete package of the engine plugin is downloaded, that is, a complete compiled third subprogram is downloaded. For example, when the second device obtains both the compiled second subprogram and the compiled third subprogram, the second device injects the compiled third subprogram and the compiled second subprogram, and runs the first application program.

In the technical solution provided in this example of this application, when the version information of the local first subprogram is different from the version information in the attribute information of the first subprogram, the incremental data corresponding to the local first subprogram is downloaded, and the incremental data and the local first subprogram are combined to generate the first subprogram corresponding to the attribute information of the first subprogram, thereby avoiding downloading the entire first subprogram, and increasing a speed of downloading the first subprogram. Similarly, when the version information of the local third subprogram is different from the version information in the attribute information of the called engine plugin, the incremental data corresponding to the local third subprogram is downloaded, and the incremental data and the local third subprogram are combined to generate the compiled third subprogram corresponding to the attribute information of the called engine plugin, avoiding downloading the entire compiled third subprogram, and increasing a speed of downloading the third subprogram.

Operation 630: Download a compiled second subprogram according to the attribute information of the second subprogram, the compiled second subprogram including an executable file in a first format, and the executable file in the first format being a file supported to be run in a browser.

In some examples, the attribute information of the second subprogram indicates an identifier and version information of the second subprogram. For example, the second device transmits a download request to the server according to an identifier and version information of the second subprogram indicated by the attribute information of the second subprogram. The download request carries the identifier and the version information of the second subprogram. For example, the server determines the corresponding second subprogram based on the identifier and the version information of the second subprogram carried in the download request. For example, the server transmits the compiled second subprogram to the second device.

Operation 640: Run the first application program according to the compiled first subprogram and the compiled second subprogram.

In some examples, the first application program is obtained according to the compiled first subprogram and the compiled second subprogram.

In some examples, the compiled first subprogram is interpreted and executed to obtain code generated by the first subprogram. When interpretation and execution of the first subprogram are completed, the compiled second subprogram is interpreted and executed, to obtain the first application program. In some examples, when it is determined that the compiled first subprogram locally exists, the cached code generated by the first subprogram is obtained. The second application program is run according to the cached code generated by the first subprogram and a downloaded second subprogram of the second application program.

For technical details that are not mentioned in this example of this application, refer to explanations and descriptions in context of other examples, and details are not described herein again.

According to the technical solution provided in this example of this application, when the second device requests to download the first application program, if the compiled first subprogram exists locally in the second device, the second device only needs to download the compiled second subprogram. Therefore, this application implements unpackaging of the engine logic and the service logic of the executable file of the first format, and in a case that the first subprogram configured for implementing the engine logic exists locally, the first subprogram does not need to be repeatedly downloaded. Therefore, in this application, reuse of the engine code (that is, the compiled first subprogram) can be implemented, and a download volume of the application program is reduced, thereby increasing a download speed of the application program.

In addition, in a case that engine code does not exist locally, the engine code is obtained from the server, to ensure smooth running of the first application program, and a download speed and running efficiency are both considered.

An apparatus example of this application is described below, which may be configured for performing the method example of this application. For details not disclosed in the apparatus example of this application, reference is made to the method example of this application.

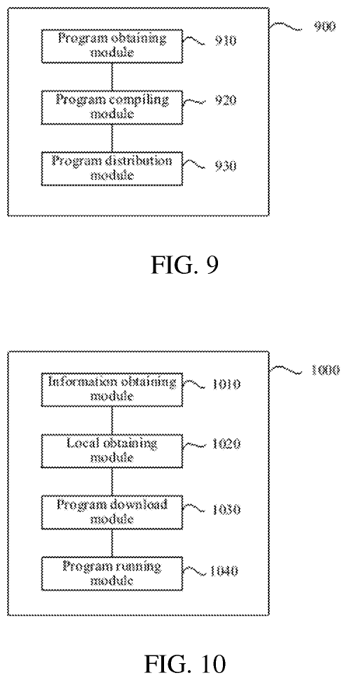

Refer to FIG. 9, which is a block diagram of an application program processing apparatus according to an example of this application. As shown in FIG. 9, the apparatus 900 may include: a program obtaining module 910, a program compiling module 920, and a program distribution module 930.

The program obtaining module 910 is configured to obtain an uncompiled first subprogram and an uncompiled second subprogram, the first subprogram being a program configured for implementing an engine logic in a first application program, and the second subprogram being a program configured for implementing a service logic in the first application program.

The program compiling module 920 is configured to compile the uncompiled second subprogram according to the uncompiled first subprogram to obtain a compiled second subprogram, the compiled second subprogram including an executable file in a first format, and the executable file in the first format being a file supported to be run in a browser.

The program distribution module 930 is configured to transmit the compiled second subprogram to a second device requesting to download the first application program, for the second device to run, in a case that a compiled first subprogram locally exists, the first application program according to the compiled second subprogram and the compiled first subprogram.

In some examples, the program compiling module 920 is configured to obtain an uncompiled third subprogram as an engine plugin, the third subprogram being a program configured for implementing a general engine logic in different application programs.

The program compiling module 920 is further configured to compile the uncompiled second subprogram according to the uncompiled first subprogram and the uncompiled third subprogram, to obtain the compiled second subprogram.

In some examples, the program compiling module 920 is configured to: for each engine function called in the uncompiled second subprogram, construct, in a case that the engine function exists in the uncompiled third subprogram, a dynamic link at a location at which the engine function is called in the uncompiled second subprogram, the dynamic link being configured for linking the location at which the engine function is called in the uncompiled second subprogram with the engine function in a compiled third subprogram.

The program compiling module 920 is further configured to: construct, in a case that the engine function does not exist in the uncompiled third subprogram and exists in the uncompiled first subprogram, a static link at the location at which the engine function is called in the uncompiled second subprogram, the static link being configured for building the engine function in the uncompiled first subprogram at the location at which the engine function is called in the uncompiled second subprogram.

The program compiling module 920 is further configured to traverse each engine function called in the uncompiled second subprogram, to construct the dynamic link or the static link, and obtain a processed second subprogram.

The program compiling module 920 is further configured to compile the processed second subprogram to obtain the compiled second subprogram.

In some examples, in a case that a dynamic link is constructed at the location at which the engine function is called in the uncompiled second subprogram, the second device obtains the engine function from the compiled third subprogram when running the compiled second subprogram.

In some examples, in a case that a static link is constructed at the location at which the engine function is called in the uncompiled second subprogram, the second device obtains the engine function from inside the compiled second subprogram when running the compiled second subprogram.

In some examples, the program compiling module 920 is further configured to compile at least one uncompiled third subprogram, to obtain at least one compiled third subprogram.

The program compiling module 920 is further configured to transmit the at least one compiled third subprogram to the second device, different third subprograms including engine functions configured for implementing different general engine logics in application programs, and the compiled third subprogram being run in the second device to become an engine plugin.

In some examples, the program compiling module 920 is further configured to divide full engine functions of a first engine to obtain at least one engine function group, each engine function group including at least two engine functions.

The program compiling module 920 is further configured to encapsulate the at least one engine function group to obtain the at least one uncompiled third subprogram.

In some examples, the program compiling module 920 is further configured to divide the full engine functions according to function types of engine functions in the full engine functions, to obtain the at least one engine function group.

The program compiling module 920 is further configured to divide the full engine functions according to use frequencies of engine functions in the full engine functions, to obtain the at least one engine function group.

In some examples, the program compiling module 920 is further configured to: run at least two application programs developed by the first engine, and determine a use frequency of each engine function in the full engine functions.

The program compiling module 920 is further configured to select engine functions whose use frequencies are greater than a threshold, to obtain the at least one engine function group.

In some examples, the program distribution module 930 is configured to select at least one first function configured for starting the first application program from functions included in the compiled second subprogram.

The program distribution module 930 is further configured to package and transmit the at least one first function to the second device.

Refer to FIG. 10, which is a block diagram of an application program processing apparatus according to another example of this application. As shown in FIG. 10, the apparatus 1000 may include: an information obtaining module 1010, a local obtaining module 1020, a program download module 1030, and a program running module 1040.

The information obtaining module 1010 is configured to obtain, based on a download request for a first application program, configuration information corresponding to the first application program, the configuration information including attribute information of a first subprogram and attribute information of a second subprogram, the first subprogram being a program configured for implementing an engine logic in the first application program, and the second subprogram being a program configured for implementing a service logic in the first application program.

The local obtaining module 1020 is configured to obtain a compiled first subprogram locally when it is determined according to the attribute information of the first subprogram that the compiled first subprogram exists locally.

The program download module 1030 is configured to download a compiled second subprogram according to the attribute information of the second subprogram, the compiled second subprogram including an executable file in a first format, and the executable file in the first format being a file supported to be run in a browser.

The program running module 1040 is configured to run the first application program according to the compiled first subprogram and the compiled second subprogram.

In some examples, the program download module 1030 is further configured to obtain the compiled first subprogram from a server when it is determined according to the attribute information of the first subprogram that the compiled first subprogram does not exist locally.

When the apparatus provided in the foregoing examples implements functions of the apparatus, it is illustrated with an example of division of each functional module. In actual application, the function distribution may be finished by different functional modules according to actual requirements. In other words, an internal structure of a device is divided into different functional modules, to implement all or some of the functions described above. In addition, the apparatus provided in the foregoing example belongs to the same concept as the method example. For a specific implementation process thereof, refer to the method example, and details are not described herein again.

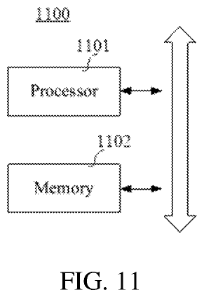

Refer to FIG. 11, which is a structural block diagram of a computer device 1100 according to an example of this application. The computer device 1100 may be any electronic device having data calculating, processing, and storage capabilities. The computer device 1100 may be configured to implement the application program processing method on the first device side or the application program processing method on the second device side provided in the foregoing example.

Generally, the computer device 1100 includes a processor 1101 and a memory 1102.

The processor 1101 may include one or more processing cores, such as a 4-core processor or an 8-core processor. The processor 1101 may be implemented in at least one hardware form of digital signal processing (DSP), a field programmable gate array (FPGA), and a programmable logic array (PLA). The processor 1101 may alternatively include a main processor and a coprocessor. The main processor is configured to process data in an active state, also referred to as a central processing unit (CPU). The coprocessor is a low-power processor configured to process data in a standby state. In some examples, the processor 1101 may be integrated with a graphics processing unit (GPU). The GPU is configured to render and draw content needing to be displayed on a display screen. In some examples, the processor 1101 may further include an artificial intelligence (AI) processor. The AI processor is configured to process a computing operation related to machine learning.

The memory 1102 may include one or more computer-readable storage media that may be non-transitory. The memory 1102 may further include a high-speed random access memory and a nonvolatile memory, for example, one or more disk storage devices or flash storage devices. In some examples, a non-transient computer-readable storage medium in the memory 1102 is configured to store a computer program, and the computer program is configured to be executed by one or more processors, so as to implement the application program processing method on the first device side or the application program processing method on the second device side.

A person skilled in the art may understand that the structure shown in FIG. 11 does not constitute a limitation on the computer device 1100, and may include more or fewer components than those shown in the figure, or combine some components, or use different component arrangements.

In an example, a computer-readable storage medium is further provided, where the storage medium stores a computer program, and the computer program is executed by a processor to implement the application program processing method on the first device side or the application program processing method on the second device side. In some examples, the computer-readable storage medium may include: a read-only memory (ROM), a random access memory (RAM), a solid state drive (SSD), an optical disc, or the like. The random access memory may include a resistive RAM (ReRAM) and a dynamic RAM (DRAM).

In an example, a computer program product is further provided. The computer program product includes a computer program, the computer program being stored in a computer-readable storage medium. The processor of the computer device reads the computer program from the computer-readable storage medium, and the processor executes the computer program, so that the computer device performs the application program processing method on the first device side or the application program processing method on the second device side.

Collection and processing of related data (such as service code) in this application need to be strictly in accordance with the requirements of relevant laws and regulations when applied in practice, and the informed consent or separate consent of the personal information subject needs to be obtained. Subsequent data use and processing need to be carried out within the scope of authorization of laws and regulations and the personal information subject.

“A plurality of” mentioned in the specification means two or more. And/or describes an association relationship for describing associated objects and represents that three relationships may exist. For example, A and/or B may represent the following three cases: Only A exists, both A and B exist, and only B exists. The character “/” generally indicates an “or” relationship between associated objects before and after the character. In addition, the operation numbers described in this specification merely show a possible execution sequence of the operations as an example. In some other examples, the foregoing operations may not be performed based on the number sequence. For example, two operations with different numbers may be performed simultaneously, or two operations with different numbers may be performed based on a sequence contrary to the sequence shown in the figure. This is not limited in the examples of this application.

The foregoing descriptions are merely example examples of this application, but are not intended to limit this application. Any modification, equivalent replacement, or improvement made within the spirit and principle of this application shall fall within the protection scope of this application.

What is claimed is:

1. An application program processing method, performed by a first device and comprising:
obtaining an uncompiled first subprogram and an uncompiled second subprogram, wherein the first subprogram is configured to implement an engine logic in a first application program, and the second subprogram is configured to implement a service logic in the first application program;
compiling the uncompiled second subprogram according to the uncompiled first subprogram to obtain a compiled second subprogram, the compiled second subprogram comprising an executable file in a first format supported to be run in a browser; and
transmitting the compiled second subprogram to a second device requesting to download the first application program, for the second device to run the first application program according to the compiled second subprogram and the compiled first subprogram.

2. The method according to claim 1, further comprising:
obtaining an uncompiled third subprogram as an engine plugin, wherein the third subprogram is configured to implement a general engine logic in different application programs, and
wherein the compiling the uncompiled second subprogram according to the uncompiled first subprogram to obtain the compiled second subprogram comprises:
compiling the uncompiled second subprogram according to the uncompiled first subprogram and the uncompiled third subprogram, to obtain the compiled second subprogram.

3. The method according to claim 2, wherein the compiling the uncompiled second subprogram according to the uncompiled first subprogram and the uncompiled third subprogram, to obtain the compiled second subprogram comprises:
for each engine function called in the uncompiled second subprogram, constructing, based on the engine function not in the uncompiled third subprogram, a dynamic link at a location at which the engine function is called in the uncompiled second subprogram, wherein the dynamic link is configured to link the location at which the engine function is called in the uncompiled second subprogram with the engine function in a compiled third subprogram;
constructing, based on the engine function not in the uncompiled third subprogram but in the uncompiled first subprogram, a static link at the location at which the engine function is called in the uncompiled second subprogram, wherein the static link is configured to build the engine function in the uncompiled first subprogram at the location at which the engine function is called in the uncompiled second subprogram;
traversing each engine function called in the uncompiled second subprogram, to construct the dynamic link or the static link, and obtain a processed second subprogram; and
compiling the processed second subprogram to obtain the compiled second subprogram.

4. The method according to claim 3, wherein:
based on that the dynamic link is constructed at the location at which the engine function is called in the uncompiled second subprogram, the second device is configured to obtain the engine function from the compiled third subprogram when running the compiled second subprogram; and
based on that the static link is constructed at the location at which the engine function is called in the uncompiled second subprogram, the second device is configured to obtain the engine function from inside the compiled second subprogram when running the compiled second subprogram.

5. The method according to claim 1, further comprising:
compiling at least one uncompiled third subprogram, to obtain at least one compiled third subprogram; and
transmitting the at least one compiled third subprogram to the second device, wherein different third subprograms comprising engine functions are configured to implement different general engine logics in application programs, and the compiled third subprogram is run as an engine plugin in the second device.

6. The method according to claim 5, further comprising:
dividing full engine functions of a first engine to obtain at least one engine function group, each engine function group comprising at least one engine function; and
encapsulating the at least one engine function group to obtain the at least one uncompiled third subprogram.

7. The method according to claim 6, wherein the dividing the full engine functions of the first engine to obtain the at least one engine function group comprises:
dividing the full engine functions according to function types of engine functions in the full engine functions, to obtain the at least one engine function group; or
dividing the full engine functions according to use frequencies of engine functions in the full engine functions, to obtain the at least one engine function group.

8. The method according to claim 7, further comprising:
running at least two application programs developed by the first engine, and
determining a use frequency of each engine function in the full engine functions, wherein the dividing the full engine functions according to use frequencies of engine functions in the full engine functions, to obtain the at least one engine function group comprises:
selecting engine functions whose use frequencies are greater than a threshold, to obtain the at least one engine function group.

9. The method according to claim 1, wherein the transmitting the compiled second subprogram to the second device requesting to download the first application program comprises:
selecting at least one first function configured for starting the first application program from functions comprised in the compiled second subprogram; and
packaging and transmitting the at least one first function to the second device.

10. An application program processing method, performed by a second device and comprising:
obtaining, based on a download request for a first application program, configuration information corresponding to the first application program, the configuration information comprising attribute information of a first subprogram and attribute information of a second subprogram, wherein the first subprogram is configured to implement an engine logic in the first application program, and the second subprogram is configured to implement a service logic in the first application program;
obtaining a compiled first subprogram locally based on determining that the compiled first subprogram exists locally according to the attribute information of the first subprogram; and
downloading a compiled second subprogram according to the attribute information of the second subprogram, the compiled second subprogram comprising an executable file in a first format supported to be run in a browser; and
running the first application program according to the compiled first subprogram and the compiled second subprogram.

11. The method according to claim 10, further comprising:
obtaining the compiled first subprogram from a server based on determining that the compiled first subprogram does not exist locally according to the attribute information of the first subprogram.

12. An application program processing apparatus, comprising circuitry configured to:
obtain an uncompiled first subprogram and an uncompiled second subprogram, wherein the first subprogram is configured to implement an engine logic in a first application program, and the second subprogram is configured to implement a service logic in the first application program;
compile the uncompiled second subprogram according to the uncompiled first subprogram to obtain a compiled second subprogram, the compiled second subprogram comprising an executable file in a first format supported to be run in a browser; and
transmit the compiled second subprogram to a second device requesting to download the first application program, for the second device to run, the first application program according to the compiled second subprogram and the compiled first subprogram.

13. The application program processing apparatus according to claim 12, wherein the circuitry is further configured to:
obtain an uncompiled third subprogram as an engine plugin, wherein the third subprogram is configured to implement a general engine logic in different application programs, and
wherein the circuitry is configured to compile the uncompiled second subprogram according to the uncompiled first subprogram to obtain the compiled second subprogram by:
compiling the uncompiled second subprogram according to the uncompiled first subprogram and the uncompiled third subprogram, to obtain the compiled second subprogram.

14. The application program processing apparatus according to claim 13, wherein the circuitry is configured to compile the uncompiled second subprogram according to the uncompiled first subprogram and the uncompiled third subprogram, to obtain the compiled second subprogram by:
for each engine function called in the uncompiled second subprogram, constructing, based on the engine function not in the uncompiled third subprogram, a dynamic link at a location at which the engine function is called in the uncompiled second subprogram, wherein the dynamic link is configured to link the location at which the engine function is called in the uncompiled second subprogram with the engine function in a compiled third subprogram;
constructing, based on the engine function not in the uncompiled third subprogram but in the uncompiled first subprogram, a static link at the location at which the engine function is called in the uncompiled second subprogram, wherein the static link is configured to build the engine function in the uncompiled first subprogram at the location at which the engine function is called in the uncompiled second subprogram;
traversing each engine function called in the uncompiled second subprogram, to construct the dynamic link or the static link, and obtain a processed second subprogram; and
compiling the processed second subprogram to obtain the compiled second subprogram.

15. The application program processing apparatus according to claim 14, wherein:
based on that the dynamic link is constructed at the location at which the engine function is called in the uncompiled second subprogram, the second device is configured to obtain the engine function from the compiled third subprogram when running the compiled second subprogram; and
based on that the static link is constructed at the location at which the engine function is called in the uncompiled second subprogram, the second device is configured to obtain the engine function from inside the compiled second subprogram when running the compiled second subprogram.

16. The application program processing apparatus according to claim 12, wherein the circuitry is further configured to:
compile at least one uncompiled third subprogram, to obtain at least one compiled third subprogram; and
transmit the at least one compiled third subprogram to the second device, wherein different third subprograms comprising engine functions are configured to implement different general engine logics in application programs, and the compiled third subprogram is run as an engine plugin in the second device.

17. The application program processing apparatus according to claim 16, wherein the circuitry is further configured to:
divide full engine functions of a first engine to obtain at least one engine function group, each engine function group comprising at least one engine function; and
encapsulate the at least one engine function group to obtain the at least one uncompiled third subprogram.

18. The application program processing apparatus according to claim 17, wherein the circuitry is configured to divide full engine functions of the first engine to obtain the at least one engine function group by:
dividing the full engine functions according to function types of engine functions in the full engine functions, to obtain the at least one engine function group; or
dividing the full engine functions according to use frequencies of engine functions in the full engine functions, to obtain the at least one engine function group.

19. The application program processing apparatus according to claim 17, wherein the circuitry is further configured to:
run at least two application programs developed by the first engine, and
determine a use frequency of each engine function in the full engine functions, wherein the circuitry is further configured to divide the full engine functions according to use frequencies of engine functions in the full engine functions, to obtain the at least one engine function group by:
selecting engine functions whose use frequencies are greater than a threshold, to obtain the at least one engine function group.

20. The application program processing apparatus according to claim 12, wherein the circuitry is configured to transmit the compiled second subprogram to the second device requesting to download the first application program by:
selecting at least one first function configured for starting the first application program from functions comprised in the compiled second subprogram; and
packaging and transmitting the at least one first function to the second device.
